(19) United States
(12) Patent Application Publication
(10) Pub. No.: US 2022/0342939 A1
(43) Pub. Date: Oct. 27, 2022

(54) METHOD FOR PROCESSING DATA, AN ELECTRONIC DEVICE, AND A COMPUTER PROGRAM PRODUCT

(71) Applicant: EMC IP Holding Company LLC, Hopkinton, MA (US)

(72) Inventors: Min Gong, Shanghai (CN); Jiacheng Ni, Shanghai (CN); Qicheng Qiu, Shanghai (CN)

(21) Appl. No.: 17/364,803

(22) Filed: Jun. 30, 2021

(30) Foreign Application Priority Data
Apr. 23, 2021 (CN) 202110442618.3

(51) Int. Cl. G06F 16/903; G06K 9/62; G06N 3/08

(52) U.S. Cl. CPC G06F 16/90335; G06K 9/6215; G06N 3/08; G06F 40/30

(57) ABSTRACT

Embodiments of the present disclosure relate to a method for processing data, an electronic device, and a computer program product. The method includes determining a first feature representation of data to be processed; determining a second feature representation that matches the first feature representation from a plurality of candidate feature representations based on the first feature representation, wherein the plurality of candidate feature representations and corresponding candidate data are stored in a storage system in association; and determining target data that matches the data to be processed from the candidate data based on the second feature representation. Through the method, matching data can be accurately determined, and the accuracy and efficiency of data retrieval can be improved.

### RELATED APPLICATION

The present application claims the benefit of priority to Chinese Patent Application No. 202110442618.3, filed on Apr. 23, 2021, which application is hereby incorporated into the present application by reference herein in its entirety.

### TECHNICAL FIELD

Embodiments of the present disclosure relate to the field of data management, and more particularly, to a method for processing data, an electronic device, and a computer program product.

### BACKGROUND

With the development of information technologies, more and more data is generated. The increase in data volume poses a great challenge to data management. Data retrieval, such as similar file retrieval, is a crucial aspect in the field of data storage. Users often need to determine files, in a storage system, that are similar in content to a queried file. However, there are many problems in data retrieval. For example, the accuracy of retrieval needs to be improved.

### SUMMARY

The following presents a simplified summary of the disclosed subject matter in order to provide a basic understanding of some aspects of the disclosed subject matter. This summary is not an extensive overview of the disclosed subject matter. It is intended to neither identify key or critical elements of the disclosed subject matter nor delineate the scope of the disclosed subject matter. Its sole purpose is to present some concepts of the disclosed subject matter in a simplified form as a prelude to the more detailed description that is presented later.

The embodiments of the present disclosure provide a method for processing data, an electronic device, and a computer program product.

According to a first aspect of the present disclosure, a method for processing data is provided. The method includes: determining a first feature representation of data to be processed; determining a second feature representation that matches the first feature representation from a plurality of candidate feature representations based on the first feature representation, wherein the plurality of candidate feature representations and corresponding candidate data are stored in a storage system in association; and determining target data that matches the data to be processed from the candidate data based on the second feature representation.

According to a second aspect of the present disclosure, an electronic device is provided. The electronic device includes at least one processor; and a memory, coupled to the at least one processor and having instructions stored thereon. The instructions, when executed by the at least one processor, cause the device to perform actions, and the actions include: determining a first feature representation of data to be processed; determining a second feature representation that matches the first feature representation from a plurality of candidate feature representations based on the first feature representation, wherein the plurality of candidate feature representations and corresponding candidate data are stored in a storage system in association; and determining target data that matches the data to be processed from the candidate data based on the second feature representation.

According to a third aspect of the present disclosure, a computer program product is provided, which is tangibly stored on a non-volatile computer-readable medium and includes machine-executable instructions. The machine-executable instructions, when executed, cause a machine to perform steps of the method in the first aspect of the present disclosure.

### BRIEF DESCRIPTION OF THE DRAWINGS

The above and other objectives, features, and advantages of the present disclosure will become more apparent by describing example embodiments of the present disclosure in more detail with reference to the accompanying drawings, and in the example embodiments of the present disclosure, the same reference numerals generally represent the same components.

FIG. 1 illustrates a schematic diagram of an example of data processing environment 100 where some embodiments of the present disclosure can be implemented;

FIG. 2 illustrates a flow chart of example method 200 for processing data according to some embodiments of the present disclosure;

FIG. 3 illustrates a flow chart of example method 300 for determining target data according to some embodiments of the present disclosure;

FIG. 4 illustrates a schematic diagram of example 400 of a picture search that can be implemented in some embodiments of the present disclosure; and

FIG. 5 illustrates a schematic block diagram of example device 500 that may be configured to implement the embodiments of the present disclosure.

The same or corresponding reference numerals in the various drawings represent the same or corresponding portions.

### DETAILED DESCRIPTION

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to”. The term “based on” should be understood as “based at least in part on”. The term “an embodiment” or “the embodiment” should be construed as “at least one embodiment”. The terms “first”, “second”, and the like may refer to different or the same objects. Other explicit and implicit definitions may also be included below.

In the embodiments of the present disclosure, the term “model” can process an input and provide a corresponding output. A neural network model is taken as an example, which generally includes an input layer, an output layer, and one or more hidden layers between the input layer and the output layer. A model used in deep learning applications (also referred to as a “deep learning model”) usually includes many hidden layers, thereby increasing the depth of a network. All the layers of a neural network model are connected in sequence, so that an output of the previous layer is provided as an input to a next layer, wherein the input layer receives an input to the neural network model, and an output from the output layer is used as a final output of the neural network model. Each layer of the neural network model includes one or more nodes (also referred to as processing nodes or neurons), and each node processes an input from the previous layer. The terms “neural network”, “model”, “network”, and “neural network model” can be used interchangeably herein.

The term “feature representation” means that data is represented by one or a set of low-dimensional vectors. The nature of the feature representation makes the data corresponding to close vectors have similar meanings. For example, a feature vector of an automobile and a feature vector of a digital product are relatively close in space because the two resources, the automobile and the digital product, belong to science and technology items. For another example, as items in picture A and items in picture B have a high degree of similarity in appearance, features of picture A and picture B are relatively close in space. Using the concept of “feature representation”, it is possible to encode objects with low-dimensional vectors and retain their meanings, which is very suitable for deep learning.

The principles of the present disclosure will be described below with reference to several example embodiments shown in the accompanying drawings. Although preferred embodiments of the present disclosure are shown in the accompanying drawings, it should be understood that these embodiments are described only to enable those skilled in the art to better understand and then implement the present disclosure, and are not intended to impose any limitation to the scope of the present disclosure.

In traditional data retrieval, retrieval is usually carried out in the following two ways: (1) Data is searched through the structured features of the data, such as a file name and file access time. However, with the explosive growth of data, the search efficiency is relatively low. (2) During data storage, the data is artificially labeled, and data searches are performed based on the labels. However, this method includes the manual addition of labels, which is costly and is often inaccurate due to human subjective factors. Therefore, traditional data retrieval methods are often unable to retrieve matching data accurately and efficiently.

In order to solve the above and other potential problems, the present disclosure provides a method for processing data. In this method, a first feature representation that can represent the content of data to be processed is first determined. Then, a second feature representation that matches the first feature representation is determined from a plurality of candidate feature representations according to the first feature representation. The plurality of candidate feature representations correspond to corresponding candidate data, and the plurality of candidate feature representations and the corresponding candidate data are stored in a storage system in association. Finally, target data that matches the data to be processed is determined from the candidate data according to the matching second feature representation. Through the method, similar data can be searched accurately and efficiently according to the feature representation of the data.

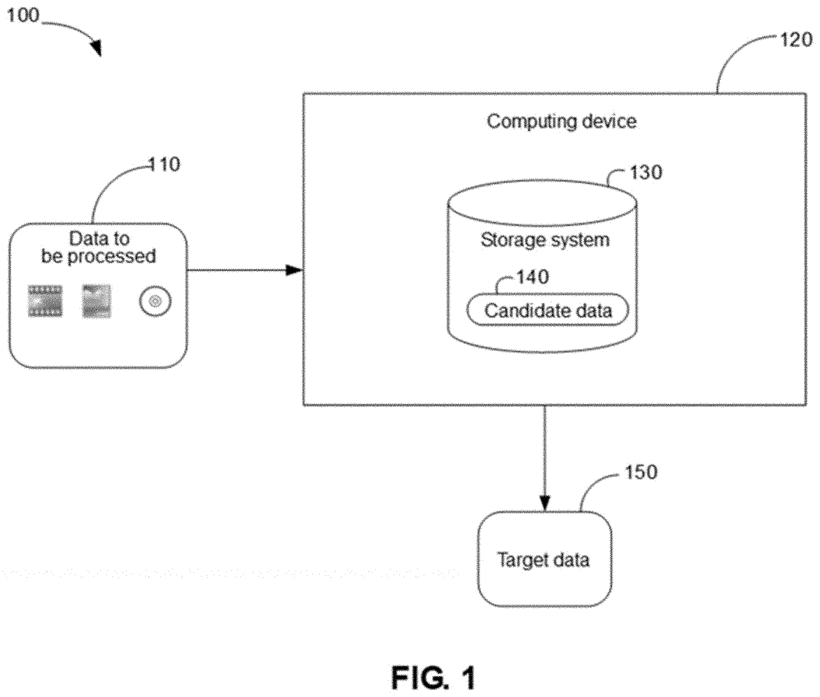

FIG. 1 illustrates a schematic diagram of an example of data processing environment 100 where some embodiments of the present disclosure can be implemented. As shown in FIG. 1A, data processing environment 100 includes data to be processed 110, computing device 120, storage system 130, candidate data 140, and target data 150. Although the drawing illustrates data to be processed and target data, it can be understood that they can also be data sets, and the present disclosure is not limited here.

Data to be processed 110 may be a retrieval content input by a user, which includes at least one of: an image, a video, audio, and text. For example, a user wants to retrieve images, videos, audios, and text that have a relatively high similarity (for example, greater than a threshold) to the input image, video, audio, and text in storage system 130.

Storage system 130 stores candidate data 140, and the user desires to retrieve target data 150 of the data to be processed from candidate data 140. Before corresponding candidate data 140 is stored in storage system 130, computing device 120 may determine its feature representation (for example, a dense vector) through a suitable deep learning model. In some embodiments, the suitable deep learning model may be a well-known trained model, such as an image classification model and a text recognition model. Alternatively, in some embodiments, the suitable deep learning model may be a model trained using a model to be trained for the stored data. Models to be trained include, but are not limited to, a support vector machine (SVM) model, a Bayesian model, a random forest model, a convolutional neural network (CNN), a recurrent neural network (RNN), a deep neural network (DNN), a deep reinforcement learning network (DQN), etc. The scope of the present disclosure is not limited in this regard.

Although computing device 120 is shown as including storage system 130, computing device 120 may also be an entity other than storage system 130. Computing device 120 may be any device with a computing capability. As a non-limiting example, computing device 120 may be any type of fixed computing device, mobile computing device, or portable computing device, and includes, but is not limited to, a desktop computer, a laptop computer, a notebook computer, a netbook computer, a tablet computer, a multimedia computer, a mobile phone, and the like. All or part of the components of computing device 120 may be distributed in a cloud. Computing device 120 at least includes a processor, a memory, and other components usually present in a general-purpose computer, so as to implement functions such as computing, storage, communication, and control.

In some embodiments, computing device 120 may determine candidate features of candidate data 140 and store them in storage system 130 in association. In some embodiments, computing device 120 may determine target data 150 that has a relatively high similarity (for example, greater than a threshold) to data to be processed 110, and present target data 150 to the user in a suitable form. This will be described in detail below.

It should be understood that environment 100 shown in FIG. 1 is only an example in which the embodiments of the present disclosure can be implemented, and is not intended to limit the scope of the present disclosure. The embodiments of the present disclosure are also applicable to other systems or architectures.

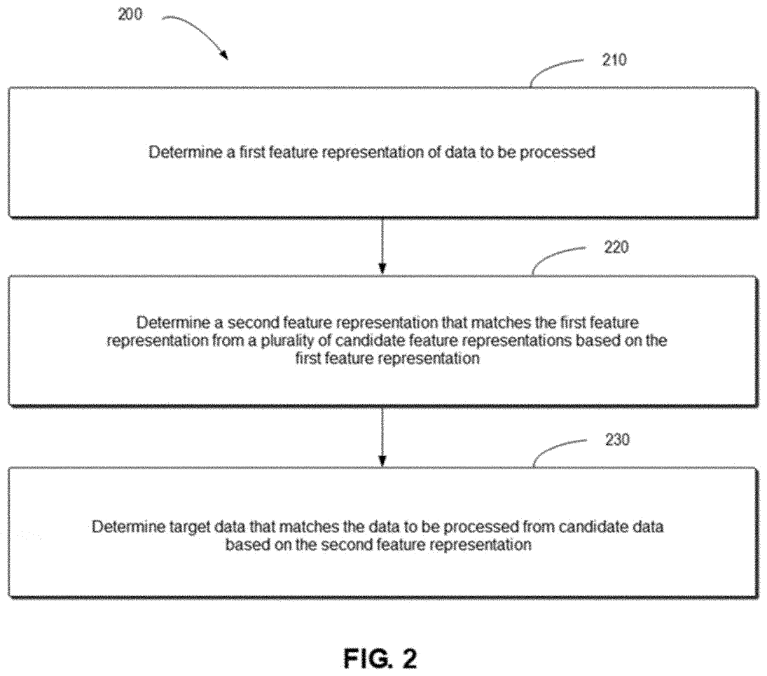

In order to more clearly understand the solutions provided by the embodiments of the present disclosure, the embodiments of the present disclosure will be further described with reference to FIGS. 2 to 4. FIG. 2 illustrates a flow chart of example method 200 for processing data according to some embodiments of the present disclosure. Example method 200 may be implemented by computing device 120 in FIG. 1. For ease of description, example method 200 will be described below with reference to FIG. 1.

At block 210 of FIG. 2, computing device 120 determines a first feature representation of data to be processed 110. For example, computing device 120 can determine the first feature representation that can characterize the content of the acquired different data to be processed through a suitable algorithm or model.

In some embodiments, data to be processed 110 includes at least one of: an image, a video, audio, and text. For example, taking text as an example, data to be processed 110 may be a keyword composed of 2 words, a sentence composed of 10 words, or a text file input by the user.

Computing device 120 may apply various algorithms and models to input data to be processed 110 to determine features that can characterize its content. In one example, computing device 120 determines a pre-trained model corresponding to the type of data to be processed 110 based on the type, and the pre-trained model is used to determine the data of the type as a feature representation of data. Then, the first feature representation of data to be processed 110 is determined according to the pre-trained model. For example, for the above-mentioned different types of data to be processed 110, there are various suitable deep learning models for processing the data. For example, for a text, there is an optical character recognition (OCR) model based on a CNN.

It can be understood that outputs of conventional deep learning models can be divided into two types: (1) a prediction result and (2) a feature map representation (for example, a vector matrix). In the present disclosure, the first feature representation may be a feature map output by a layer closest to a last fully connected layer, and the feature map can usually represent data to be processed 110 most accurately in the form of a dense vector.

In some embodiments, computing device 120 can determine a model for text recognition from a database (for example, a pre-trained model database) if it determines that data to be processed 110 is text data, and then determine the first feature representation of the text data through the model. In some embodiments, computing device 120 can determine a model for image classification from the database (for example, the pre-trained model database) if it determines that data to be processed 110 is image data, and then determine the first feature representation of the image data through the model.

Additionally or alternatively, computing device 120 may acquire the same type of data as the data to be processed 110 from storage system 130 if computing device 120 cannot acquire a model corresponding to the data to be processed 110. Then, the acquired data and a suitable model to be trained are used to acquire a “customized” model for the data to be processed.

The feature representation of the data to be processed can be accurately acquired by determining the type of the data to be processed and then using the suitable model in the database. For a model that does not have a suitable model, the model can be trained based on the corresponding type of data. An accurate feature representation lays a foundation for subsequent similar data retrieval.

At block 220 of FIG. 2, computing device 120 determines a second feature representation that matches the first feature representation from a plurality of candidate feature representations based on the first feature representation, wherein the plurality of candidate feature representations and corresponding candidate data are stored in a storage system in association. For example, after determining the first feature representation of data to be processed 110, based on this feature representation, computing device 120 determines a feature representation in the storage system that matches the feature representation.

First, candidate data 140 and candidate feature identifiers stored in storage system 130 are described. Computing device 120 may first use a suitable model to determine the candidate feature representations of candidate data 140 when candidate data 140 is to be stored in the storage system. This process is similar to the process of step 210, and will not be repeated here. Computing device 140 may then cause the candidate feature representations and corresponding candidate data 140 to be stored in storage system 130 in association, for example, as metadata of candidate data 140.

In order to determine target data 150 similar to data to be processed 110, computing device 120 may first determine features that match a first feature identifier from the plurality of candidate feature representations. In one example, computing device 110 determines that a feature representation of a matching degree with the first feature representation greater than a threshold, of the plurality of candidate feature representations, is the second feature representation.

In some embodiments, computing device 110 may calculate the cosine distance between the first feature representation and the candidate feature representation as the matching degree, and then determine that the candidate feature representation matches the first feature representation if the matching degree is greater than the threshold. The cosine distance represents the cosine value of the included angle between two feature representations (two vectors) in space, that is, the included angle of the vectors in space is considered instead of the absolute lengths of the vectors.

In some embodiments, computing device 110 may calculate the Euclidean distance between the first feature representation and the candidate feature representation as the matching degree, and then determine that the candidate feature representation matches the first feature representation if the matching degree is greater than the threshold. The Euclidean distance represents the distance between the end points of two feature representations (two vectors) in space.

Additionally or alternatively, in some embodiments, computing device 110 may simultaneously calculate the Euclidean distance and the cosine distance between the first feature representation and the candidate feature representation. Then, different weights are assigned to them to determine the matching degree between the first feature representation and the candidate feature representation.

It can be understood that in different scenarios (such as different data types and user requests or needs), the different metrics between feature representations can be set as the matching degree between them, and other similarity calculation methods can be used, such as the Jaccard Distance. The present disclosure is not limited here. The matching degree between feature representations is calculated by flexibly using different algorithms according to different scenarios, so that a matching feature representation can be accurately determined, making subsequent data retrieval results more accurate.

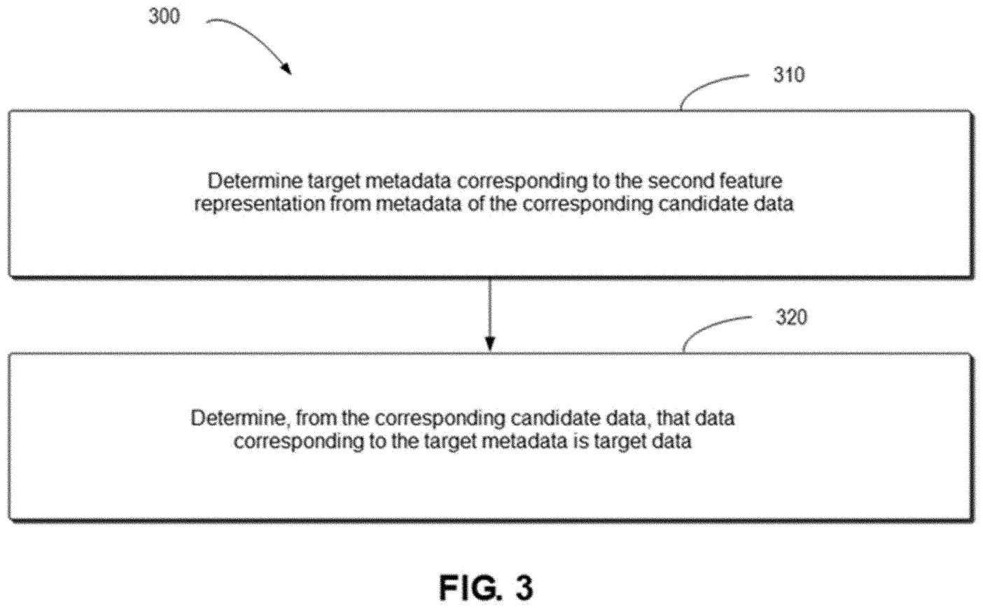

At block 230 of FIG. 2, computing device 120 determines target data 150 matching data to be processed 110 from the candidate data based on the second feature representation. This process will be further described in conjunction with FIG. 3. FIG. 3 illustrates a flow chart of example method 300 for determining target data according to some embodiments of the present disclosure.

At block 310 of FIG. 3, the plurality of aforementioned candidate feature representations are stored as the metadata of corresponding candidate data 140, and computing device 120 determines target metadata corresponding to the second feature representation from the metadata of corresponding candidate data 140. For example, when the feature representations are stored as the metadata, computing device 120 may first determine a second feature that matches the first feature according to the method in 220 above. The target metadata where the second feature is positioned is then determined.

At block 320 of FIG. 3, computing device 120 determines that data corresponding to the target metadata from corresponding candidate data 140 is the target data. Computing device 120 may determine the target data corresponding to the target metadata after determining the target metadata.

In some embodiments, the pre-trained model for determining data to be processed 110 as the first feature representation is the same as a model for determining the target data as the second feature representation. By applying the same model to determine the feature representations of similar data, the retrieval of similar data can be more accurate.

According to the embodiments of the present disclosure, by means of this method, the feature representation of the data is stored as the metadata of the data during data storage, which can accurately label the data and save on labor costs. During data retrieval, matching (highly similar) data can be accurately determined through the matching metadata determined, according to a feature representation of data to be retrieved, from the metadata.

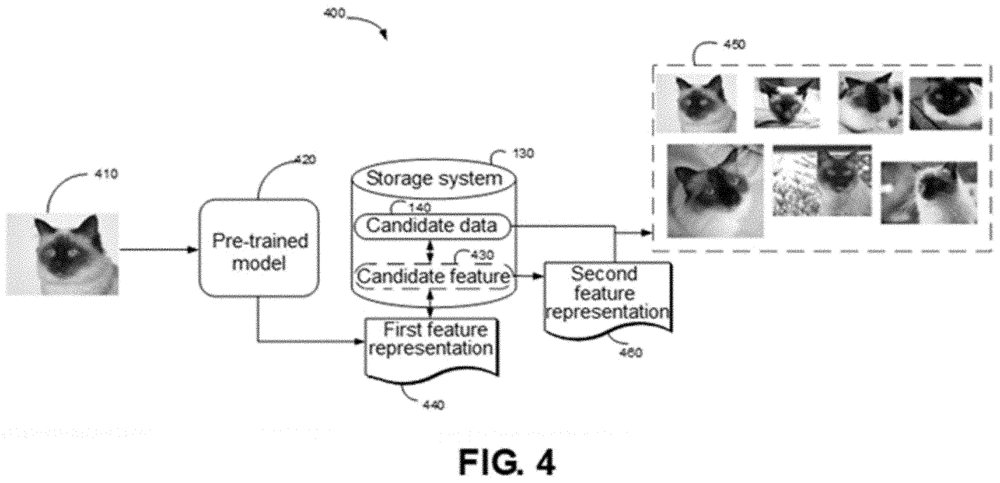

FIG. 4 illustrates a schematic diagram of example 400 of a picture search that can be implemented in some embodiments of the present disclosure. As shown in the figure, the data to be processed is picture 410 including a cat, that is, a user wants to retrieve one or more pictures 450 similar to picture 410 in storage system 130. Computing device 120 can determine first feature representation 420 of the picture according to corresponding pre-trained model 420 if it determines that the data type is a picture. Next, computing device 120 may determine one or more second feature representations 460 that match first feature representation 440 from candidate features 430 in the storage system (for example, a metadata storage space). Then, corresponding candidate data 140 is determined through second feature representations 460. Finally, candidate data corresponding to candidate data 140 is visually presented to the user, for example, one or more pictures 450 are returned to the user.

Computing device 120 may also sort the target data according to the matching degree between one or more second feature representations 460 and first feature representation 440, and then present one or more pictures 450 to the user in the sorted order. This makes retrieval results more intuitive, which in turn can improve the user experience.

Although pictures are taken as an example above, it can be understood that the data to be processed may also be in various forms such as text, speech, and video. For data in the form of speech, computing device 120 can convert it into text data. For the form of video data, computing device 120 can convert it into picture form.

It can also be understood that, for text data, for example, the method of the above embodiment has the advantage that semantically similar data can be determined. That is, when a text segment is input, the above method can present to the user text that is semantically similar to the segment, rather than just presenting text including keywords from the segment to the user. This makes data retrieval results more accurate.

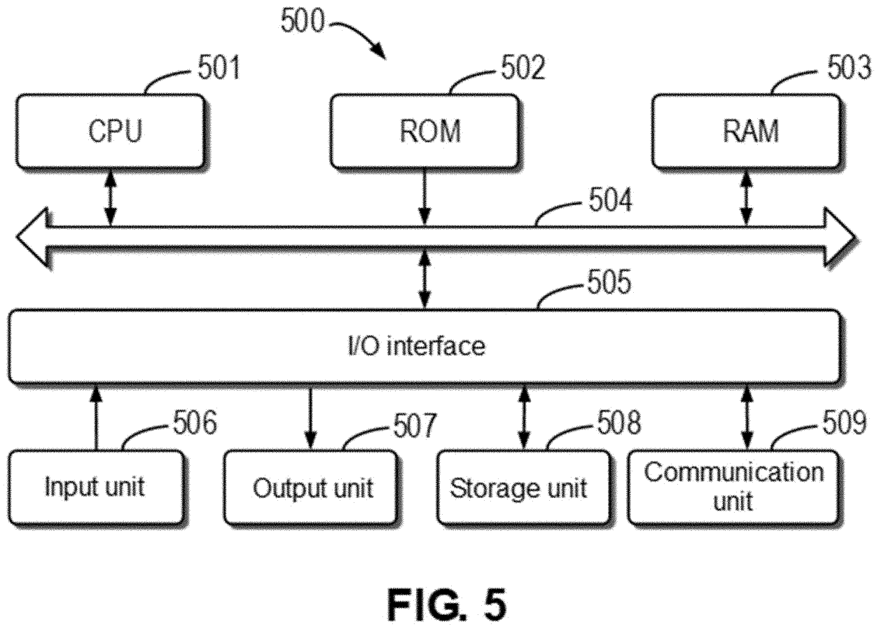

FIG. 5 illustrates a schematic block diagram of example device 500 that may be configured to implement an embodiment of content of the present disclosure. For example, storage manager 130 as shown in FIG. 1 may be implemented by device 500. As shown in the drawing, device 500 includes central processing unit CPU 501 that may perform various appropriate actions and processing according to computer program instructions stored in read-only memory (ROM) 502 or computer program instructions loaded from storage unit 508 into random access memory (RAM) 503. In RAM 503, various programs and data required for the operation of storage device 500 may also be stored. CPU 501, ROM 502, and RAM 503 are connected to each other through bus 504. Input/output (I/O) interface 505 is also connected to bus 504.

A plurality of components in device 500 are connected to I/O interface 505, including: input unit 506, such as a keyboard or a mouse; output unit 507, such as various types of displays and speakers; storage unit 508, such as a magnetic disk or an optical disk; and communication unit 509, such as a network card, a modem, or a wireless communication transceiver. Communication unit 509 allows device 500 to exchange information/data with other devices over a computer network such as the Internet and/or various telecommunication networks.

The various methods and processes described above, such as methods 200 and 300, may be performed by processing unit 501. For example, in some embodiments, methods 200 and 300 may be implemented as a computer software program that is tangibly included in a machine-readable medium, such as storage unit 508. In some embodiments, some or all of the computer programs may be loaded and/or installed onto device 500 via ROM 502 and/or communication unit 509. When the computer programs are loaded to RAM 503 and executed by CPU 501, one or more actions in methods 200 and 300 described above can be executed.

The present disclosure may be a method, an apparatus, a system, and/or a computer program product. The computer program product may include a computer-readable storage medium on which computer-readable program instructions for performing various aspects of the present disclosure are loaded.

The computer-readable storage medium may be a tangible device capable of retaining and storing instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the foregoing. More specific examples, as a non-exhaustive list, of computer-readable storage media include: a portable computer disk, a hard disk, a random access memory (RAM), a read-only memory (ROM), an erasable programmable read-only memory (EPROM) or a flash memory, a static random access memory (SRAM), a portable compact disc read-only memory (CD-ROM), a digital versatile disc (DVD), a memory stick, a floppy disk, a mechanical encoding device (for example, a punch card or a raised structure in a groove with instructions stored thereon), and any suitable combination of the foregoing. Computer-readable storage media used herein are not to be interpreted as transient signals per se, such as radio waves or other freely propagating electromagnetic waves, electromagnetic waves propagating through waveguides or other transmission media (for example, light pulses through fiber optic cables), or electrical signal transmitted via electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. The network adapter card or network interface in each computing/processing device receives computer-readable program instructions from the network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, status setting data, or source code or object code written in any combination of one or more programming languages, including object-oriented programming languages, such as Smalltalk and C++, as well as conventional procedural programming languages, such as “C” language or similar programming languages. The computer-readable program instructions may be executed entirely on a user computer, partly on a user computer, as a standalone software package, partly on a user computer and partly on a remote computer, or entirely on a remote computer or a server. When a remote computer is involved, the remote computer may be connected to a user computer over any kind of network, including a local area network (LAN) or a wide area network (WAN), or may be connected to an external computer (e.g., connected over the Internet using an Internet service provider). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

Various aspects of the present disclosure are described here with reference to flowcharts and/or block diagrams of the method, the apparatus/system, and the computer program product according to the embodiments of the present disclosure. It should be understood that each block of the flow charts and/or block diagrams and combinations of blocks in the flow charts and/or block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce an apparatus for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flowcharts and block diagrams in the drawings illustrate the architectures, functions, and operations of possible implementations of the systems, methods, and computer program products according to a plurality of embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the drawings. For example, two successive blocks may actually be executed basically in parallel, and sometimes they may also be executed in an inverse order, which depends on the functions involved. It should be further noted that each block in the block diagrams and/or flow charts as well as a combination of blocks in the block diagrams and/or flow charts may be implemented using a special hardware-based system that executes specified functions or actions, or using a combination of special hardware and computer instructions.

Various embodiments of the present disclosure have been described above. The foregoing description is illustrative rather than exhaustive, and is not limited to the disclosed embodiments. Numerous modifications and alterations are apparent to those of ordinary skill in the art without departing from the scope and spirit of the illustrated embodiments. The selection of terms as used herein is intended to best explain the principles and practical applications of the various embodiments or technical improvements to technologies on the market, or to enable other persons of ordinary skill in the art to understand the embodiments disclosed here.

What is claimed is:

1. A method, comprising:
determining, by a system comprising a processor, a first feature representation of data to be processed;
based on the first feature representation, determining a second feature representation that matches the first feature representation from a plurality of candidate feature representations, wherein the plurality of candidate feature representations and corresponding candidate data are stored in a storage system in association; and
based on the second feature representation, determining, from the corresponding candidate data, target data that matches the data to be processed.

2. The method according to claim 1, wherein the data to be processed is first data, wherein the plurality of candidate feature representations is stored as metadata of the corresponding candidate data, and wherein the determining the target data comprises:
determining target metadata corresponding to the second feature representation from the metadata of the corresponding candidate data; and
determining, from the corresponding candidate data, that second data corresponding to the target metadata is the target data.

3. The method according to claim 1, wherein the determining the first feature representation comprises:
determining preprocessed data corresponding to a second type, based on a first type of data to be processed, wherein the preprocessed data is used to determine the data of the first type as a feature representation of the data; and
determining the first feature representation of the data to be processed according to the preprocessed data.

4. The method according to claim 3, wherein the preprocessed data that determines the data to be processed as the first feature representation comprises a same model as a model for determining the target data as the second feature representation.

5. The method according to claim 1, wherein the determining the second feature representation comprises:
determining that a feature representation of a matching degree with the first feature representation greater than a threshold, of the plurality of candidate feature representations, is the second feature representation.

6. The method according to claim 5, wherein the matching degree is determined based on one of a Euclidean distance between the feature representation and first feature representation and a cosine distance between the feature representation and first feature representation.

7. The method according to claim 1, wherein the data to be processed comprises at least one of:
image data representative of an image,
video data representative of a video,
audio data representative of audio, and
textual data representative of text.

8. A device, comprising:
at least one processor; and
a memory coupled to the at least one processor and having instructions stored thereon, wherein the instructions, when executed by the at least one processor, cause the device to perform operations, comprising:
determining a first feature representation of data to be processed;
determining a second feature representation that matches the first feature representation from a group of candidate feature representations based on the first feature representation, wherein the group of candidate feature representations and candidate data corresponding to the group of candidate feature representations are stored and associated in a storage system; and
determining target data that matches the data to be processed from the candidate data based on the second feature representation.

9. The device according to claim 8, wherein the data to be processed is first data, wherein the group of candidate feature representations is stored as metadata of the candidate data, wherein the determining the target data comprises:
determining target metadata corresponding to the second feature representation from the metadata of the candidate data; and
determining, from the corresponding candidate data, that second data corresponding to the target metadata is the target data.

10. The device according to claim 8, wherein the determining the first feature representation comprises:
determining preprocessed data corresponding to a first type, based on a second type of data to be processed, wherein the preprocessed data is used to determine the data of the second type as a feature representation of the data; and
determining the first feature representation of the data to be processed according to the preprocessed data.

11. The device according to claim 10, wherein the preprocessed data that determines the data to be processed as the first feature representation comprises a same model as a model for determining the target data as the second feature representation.

12. The device according to claim 8, wherein the determining the second feature representation comprises:
determining that a feature representation of a matching degree with the first feature representation greater than a threshold, of the group of candidate feature representations, is the second feature representation.

13. The device according to claim 12, wherein the matching degree is determined based on at least one of a Euclidean distance or a cosine distance.

14. The device according to claim 8, wherein the data to be processed comprises at least one of:
an image,
a video,
audio, and
text.

15. A computer program product, wherein the computer program product is tangibly stored on a non-transitory computer-readable medium and comprises machine-executable instructions, and the machine-executable instructions, when executed, cause a machine to perform operations, comprising:
determining a first feature representation of data to be processed;
based on the first feature representation, determining a second feature representation that matches the first feature representation from candidate feature representations, wherein the candidate feature representations and corresponding candidate data are stored in a storage system in association; and
based on the second feature representation, determining, from the corresponding candidate data, target data that matches the data to be processed.

16. The computer program product according to claim 15, wherein the data to be processed is first data, wherein the candidate feature representations is stored as metadata of the corresponding candidate data, and wherein the determining the target data comprises:
determining target metadata corresponding to the second feature representation from the metadata of the corresponding candidate data; and
determining, from the corresponding candidate data, that second data corresponding to the target metadata is the target data.

17. The computer program product according to claim 15, wherein the determining the first feature representation comprises:
determining preprocessed data corresponding to a second type, based on a first type of data to be processed, wherein the preprocessed data is used to determine the data of the first type as a feature representation of the data; and
determining the first feature representation of the data to be processed according to the preprocessed data.

18. The computer program product according to claim 17, wherein the preprocessed data that determines the data to be processed as the first feature representation comprises a same model as a model for determining the target data as the second feature representation.

19. The computer program product according to claim 15, wherein the determining the second feature representation comprises:
determining that a feature representation of a matching degree with the first feature representation greater than a threshold, of the candidate feature representations, is the second feature representation, wherein the matching degree is determined based on one of a Euclidean distance between the feature representation and first feature representation and a cosine distance between the feature representation and first feature representation.

20. The computer program product according to claim 19, wherein the data to be processed comprises at least one of:
image data representative of an image,
video data representative of a video,
audio data representative of audio, and
textual data representative of text.
